(19) United States
(12) Patent Application Publication
(10) Pub. No.: US 2025/0198577 A1
(43) Pub. Date: Jun. 19, 2025

(54) READING LAMP

(71) Applicant: Shenzhen Oushili Industrial Co., Ltd., Shenzhen (CN)

(72) Inventor: Hechuan YAN, Shenzhen (CN)

(73) Assignee: Shenzhen Oushili Industrial Co., Ltd., Shenzhen (CN)

(21) Appl. No.: 19/065,026

(22) Filed: Feb. 27, 2025

(30) Foreign Application Priority Data
May 28, 2024 (CN) 202421191239.7

(51) Int. Cl. F21L 4/04; F21V 15/01; F21V 21/088; F21V 23/00; F21V 23/04; F21W 131/30; F21Y 101/00; F21Y 103/10; F21Y 113/20

(52) U.S. Cl. CPC F21L 4/04; F21V 15/012; F21V 21/0885; F21V 23/002; F21V 23/005; F21V 23/0428; F21W 2131/3005; F21Y 2101/00; F21Y 2103/10; F21Y 2113/20

(57) ABSTRACT

A reading lamp includes a flexible carrier, two clamping components, a first lighting lamp and a second lighting lamp. The flexible carrier is deformable. The two clamping components are installed at both opposite ends of the flexible carrier respectively; the first lighting lamp is embedded in the middle section position of the flexible carrier; and the second lighting lamp is installed on the clamping component. The reading lamp provided in the present application combines the advantages of neckband and clamping reading lamps, and can provide flexible and efficient lighting under different usage scenarios.

### CROSS-REFERENCE TO RELATED APPLICATIONS

This application claims priority to Chinese Patent Application No. 202421191239.7, filed on May 28, 2024, the content of which is incorporated herein by reference in its entirety.

### TECHNICAL FIELD

The present application relates to the technical field of lighting equipment, in particular to a reading lamp.

### BACKGROUND

As a portable lighting tool, the reading lamp is widely used at night or in low-light environments to provide enough light for people to read books or perform other close visual activities. With the development of science and technology and the diversification of user needs, a variety of types of reading lamps have appeared on the market, wherein neckband and clamping reading lamps are favored by users because of their portability and practicality.

The design of the neckband reading lamp allows the users to fix the lamp to the neck, allowing both hands to manipulate books or other objects freely. This design is particularly suitable for users who need to stand or walk for long periods of time to read, such as during commuting or outdoor activities. However, the neckband reading lamp is usually small in volume and limited in lighting range, making it difficult to provide sufficient light for a large range of reading.

The clamping reading lamp is fixed to the books or other reading materials through clamping components, which can provide more concentrated and stable lighting for reading areas. The clamping reading lamp is generally provided with adjustable lamp arms to accommodate different sizes of books and the reading habits of the users. However, the clamping reading lamp is not flexible enough when moving or changing the reading position, and is difficult to use in an environment without a suitable gripper.

Although the existing neckband and clamping reading lamps have respective advantages, they fail to provide a solution that meets the need of fixed reading lighting and provides lighting in mobile or gripper-free environments. In actual use, the users often need to frequently change different types of reading lamps according to specific scenarios, which not only increases the burden of carrying, but also affects the reading experience.

### SUMMARY

The technical problem to be solved in the present application is to provide a reading lamp that provides flexible and efficient lighting in different usage scenarios through combination of the advantages of the neckband and clamping reading lamps.

In order to solve the above technical problems, the technical solution adopted in the present application is:
a reading lamp including:
a flexible carrier, which is deformable;
two clamping components, installed at both opposite ends of the flexible carrier respectively;
a first lighting lamp, embedded in a middle section position of the flexible carrier; and a second lighting lamp, installed on the clamping component.

Further, the material of the flexible carrier is a shape memory polymer, silicone, thermoplastic polyurethane, polyvinyl chloride or nickel-titanium alloy.

Further, the clamping component includes a housing and a clamping element installed on an outer side of the housing; the housing is installed on an end part of the flexible carrier; the second lighting lamp is installed on the housing; and an electric control assembly electrically connected with the second lighting lamp and the first lighting lamp is arranged in the housing.

Further, the electric control assembly includes a control circuit board, a power supply and a control key; the power supply is electrically connected with the control circuit board; the control circuit board is electrically connected with the first lighting lamp and the second lighting lamp; and the control key is installed outside the housing and is used for sending a control signal to the control circuit board.

Further, the flexible carrier is provided with a wire trough, one end of the housing near the flexible carrier is provided with a wire hole, and the wire hole is arranged against the wire trough.

Further, the clamping element and the housing are formed as an integrated structure; the clamping element includes a fixing part and an elastic clamping part which are connected; the fixing part is connected with the housing; and a clamping gap is formed between the elastic clamping part and the housing.

Further, the clamping element and/or the housing are provided with a protecting element which is located in the clamping gap.

Further, the material of the protecting element is rubber, silicone, polyvinyl chloride, thermoplastic polyurethane, sponge, foam, microfiber or leather.

Further, the clamping element is provided with a first magnetic attraction element, and the housing is provided with a second magnetic attraction element for magnetic attraction with the first magnetic attraction element.

Further, the first lighting lamp is a flexible lamp strip.

The beneficial effects of the present application are: the reading lamp provided in the present application combines the advantages of the neckband and clamping reading lamps, and can provide flexible and efficient lighting under different usage scenarios. The first lighting lamp and the clamping components are carried by arranging the deformable flexible carrier. The first lighting lamp is embedded in the middle section position of the flexible carrier, and specially designed for clamping type usage scenarios, and can provide centralized and uniform lighting, thereby optimizing the reading experience of the users. The second lighting lamp is installed on the clamping component. When the reading lamp is converted to a neckband usage scenario, the second lighting lamp provides necessary lighting, so that the users can enjoy sufficient light when walking or standing while reading. The users can realize the conversion of reading modes by adjusting the shape of the flexible carrier combined with the switching of the first lighting lamp and the second lighting lamp, which ensures that the best lighting effect can be provided in different use modes, thereby greatly enhancing the versatility and the user experience of the reading lamp.

### BRIEF DESCRIPTION OF THE DRAWINGS

FIG. 1 is a structural schematic diagram of a reading lamp in embodiment 1 of the present application.

FIG. 2 is a structural schematic diagram of a reading lamp in embodiment 1 of the present application from another perspective.

FIG. 3 is a sectional structural schematic diagram of a reading lamp in embodiment 1 of the present application.

### DETAILED DESCRIPTION OF THE EMBODIMENTS

To explain the technical content, achieved purposes and effects of the present application in detail, the present application is illustrated below in combination with the implementation modes and the drawings.

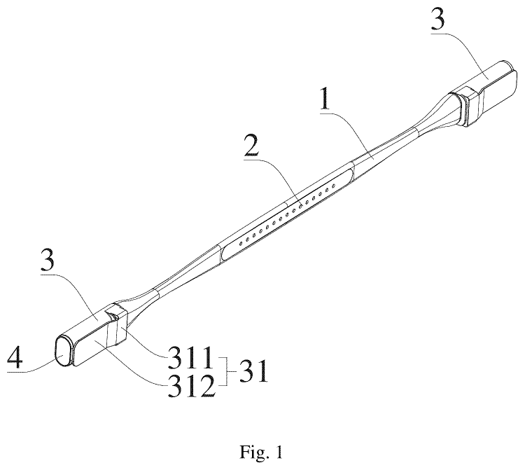

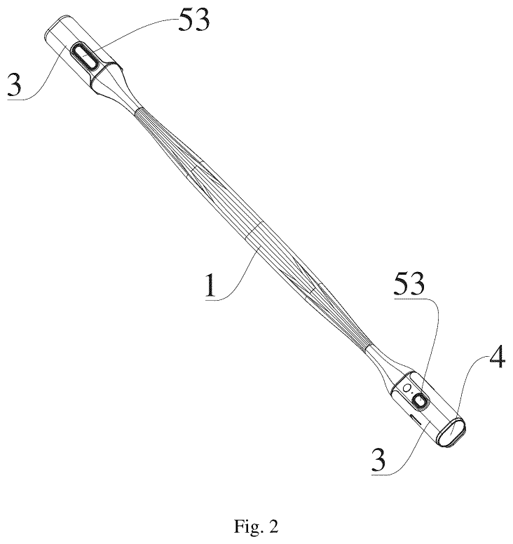

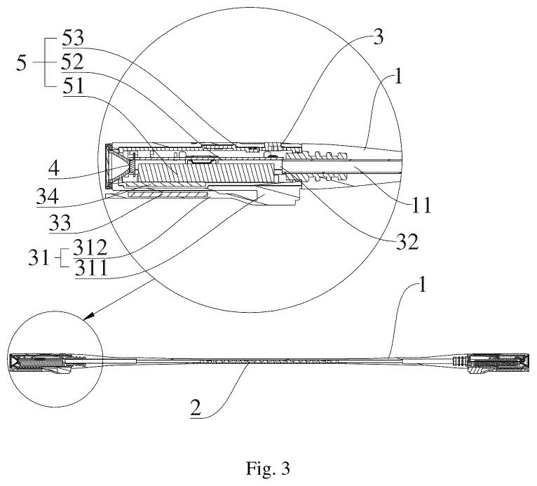

By referring to FIG. 1 to FIG. 3, a reading lamp includes:
a flexible carrier 1, which is deformable;
two clamping components, installed at both opposite ends of the flexible carrier 1 respectively;
a first lighting lamp 2, embedded in a middle section position of the flexible carrier 1; and
a second lighting lamp 4, installed on the clamping component.

It can be seen from the above description that the beneficial effects of the present application are as follows. The first lighting lamp 2 and the clamping components are carried by arranging the deformable flexible carrier 1. The first lighting lamp 2 is embedded in the middle section position of the flexible carrier 1, and specially designed for clamping type usage scenarios, and can provide centralized and uniform lighting, thereby optimizing the reading experience of the users. The second lighting lamp 4 is installed on the clamping component. When the reading lamp is converted to a neckband usage scenario, the second lighting lamp 4 provides necessary lighting, so that the users can enjoy sufficient light when walking or standing while reading. The users can realize the conversion of reading modes by adjusting the shape of the flexible carrier 1 combined with the switching of the first lighting lamp 2 and the second lighting lamp 4, which ensures that the best lighting effect can be provided in different use modes, thereby greatly enhancing the versatility and the user experience of the reading lamp.

Further, the material of the flexible carrier 1 is a shape memory polymer, silicone, thermoplastic polyurethane, polyvinyl chloride or nickel-titanium alloy.

It can be seen from the above description that the material of the flexible carrier 1 can be selected according to the actual application needs.

Further, the clamping component includes a housing 3 and a clamping element 31 installed on an outer side of the housing 3; the housing 3 is installed on an end part of the flexible carrier 1; the second lighting lamp 4 is installed on the housing 3; and an electric control assembly 5 electrically connected with the second lighting lamp 4 and the first lighting lamp 2 is arranged in the housing 3.

It can be seen from the above description that the clamping component simplifies the circuit connection by integrating the electric control assembly 5, making a product more compact and user-friendly.

Further, the electric control assembly 5 includes a control circuit board 52, a power supply 51 and a control key 53; the power supply 51 is electrically connected with the control circuit board 52; the control circuit board 52 is electrically connected with the first lighting lamp 2 and the second lighting lamp 4; and the control key 53 is installed outside the housing 3 and is used for sending a control signal to the control circuit board 52.

It can be seen from the above description that the integrated design of the control circuit board 52, the power supply 51 and the control key 53 makes it convenient for the users to control a switch and the brightness of the lighting lamps, and improves the convenience of operation.

Further, the flexible carrier 1 is provided with a wire trough 11, one end of the housing 3 near the flexible carrier 1 is provided with a wire hole 32, and the wire hole 32 is arranged against the wire trough 11.

It can be seen from the above description that the design of the wire trough 11 and the wire hole 32 skillfully solves the problem of wire management, avoids the chaos of the wire, improves the cleanliness and the beauty of the product, and also reduces the risk of wire damage.

Further, the clamping element 31 and the housing 3 are formed as an integrated structure; the clamping element 31 includes a fixing part 311 and an elastic clamping part 312 which are connected; the fixing part 311 is connected with the housing 3; and a clamping gap is formed between the elastic clamping part 312 and the housing 3.

It can be seen from the above description that the integrated structural design of the clamping element 31 and the housing 3 not only simplifies the manufacturing process, but also enhances the overall stability and durability. The clamping gap formed by the elastic clamping part 312 can adapt to books of different thicknesses, which improves the universality and the practicability of the clamping components.

Further, the clamping element 31 and/or the housing 3 are provided with a protecting element which is located in the clamping gap.

It can be seen from the above description that the protecting element is arranged in the clamping gap, which effectively prevents the clamping component from contacting the books directly, thereby protecting the books from damage.

Further, the material of the protecting element is rubber, silicone, polyvinyl chloride, thermoplastic polyurethane, sponge, foam, microfiber or leather.

It can be seen from the above description that the material of the protecting element can be set according to the actual application needs.

Further, the clamping element 31 is provided with a first magnetic attraction element 33, and the housing 3 is provided with a second magnetic attraction element 34 for magnetic attraction with the first magnetic attraction element 33.

It can be seen from the above description that the design of the magnetic attraction elements provides a fast and simple clamping and release mechanism. The users can easily fix or remove the reading lamp. This characteristic greatly improves the use convenience of the product.

Further, the first lighting lamp 2 is a flexible lamp strip.

It can be seen from the above description that the use of the flexible lamp strip makes the first lighting lamp 2 better adapt to the deformation of the flexible carrier 1, which provides a more uniform and extensive lighting area, and enhances the practicality and the flexibility of the reading lamp.

By referring to FIG. 1 to FIG. 3, embodiment 1 of the present application is: a reading lamp including a flexible carrier 1, two clamping components, a first lighting lamp 2 and a second lighting lamp 4. The flexible carrier 1 is deformable. Specifically, the flexible carrier 1 of the reading lamp can be bent into a U-shaped shape, so as to adapt to the neck of a human body. Specifically, the shape of the flexible carrier can be adjusted according to the actual application needs. The material of the flexible carrier 1 is a shape memory polymer, silicone, thermoplastic polyurethane, polyvinyl chloride or nickel-titanium alloy. Thus, the flexible carrier 1 has certain flexibility, plasticity and durability. The two clamping components are installed on both opposite ends of the flexible carrier 1 respectively. The first lighting lamp 2 is embedded in the middle section position of the flexible carrier 1. Specifically, the first lighting lamp 2 is a flexible lamp strip. Thus, the first lighting lamp 2 can better adapt to the deformation of the flexible carrier 1, which provides a more uniform and extensive lighting area, and enhances the practicality and the flexibility of the reading lamp. The second lighting lamp 4 is installed on the clamping component. It is easy to understand that the first lighting lamp 2 and the clamping components are carried by arranging the deformable flexible carrier 1. The first lighting lamp 2 is embedded in the middle section position of the flexible carrier 1, and specially designed for clamping type usage scenarios, and can provide centralized and uniform lighting, thereby optimizing the reading experience of the users. The second lighting lamp 4 is installed on the clamping component. When the reading lamp is converted to a neckband usage scenario, the second lighting lamp 4 provides necessary lighting, so that the users can enjoy sufficient light when walking or standing while reading. The users can realize the conversion of reading modes by adjusting the shape of the flexible carrier 1 combined with the switching of the first lighting lamp 2 and the second lighting lamp 4, which ensures that the best lighting effect can be provided in different use modes, thereby greatly enhancing the versatility and the user experience of the reading lamp.

Preferably, the clamping component includes a housing 3 and a clamping element 31 installed on an outer side of the housing 3; the housing 3 is installed on an end part of the flexible carrier 1; the second lighting lamp 4 is installed on the housing 3; and an electric control assembly 5 electrically connected with the second lighting lamp 4 and the first lighting lamp 2 is arranged in the housing 3. The clamping component simplifies the circuit connection by integrating the electric control assembly 5, making a product more compact and user-friendly. Specifically, the electric control assembly 5 includes a control circuit board 52, a power supply 51 and a control key 53; the power supply 51 is electrically connected with the control circuit board 52; the control circuit board 52 is electrically connected with the first lighting lamp 2 and the second lighting lamp 4; and the control key 53 is installed outside the housing 3 and is used for sending a control signal to the control circuit board 52. It is understandable that the integrated design of the control circuit board 52, the power supply 51 and the control key 53 makes it convenient for the users to control a switch and the brightness of the lighting lamps, and improves the convenience of operation.

In the present embodiment, an installation cavity for installing the first lighting lamp 2 is arranged at the position of the flexible carrier 1 corresponding to the first lighting lamp 2. The end part of the flexible carrier 1 is also provided with a wire trough 11 communicated with the installation cavity. One end of the housing 3 near the flexible carrier 1 is provided with a wire hole 32, and the wire hole 32 is arranged against the wire trough 11. The design of the wire trough 11 and the wire hole 32 skillfully solves the problem of wire management, avoids the chaos of the wire, improves the cleanliness and the beauty of the product, and also reduces the risk of wire damage. Specifically, the clamping element 31 and the housing 3 are formed as an integrated structure; the clamping element 31 includes a fixing part 311 and an elastic clamping part 312 which are connected; the fixing part 311 is connected with the housing 3; and a clamping gap is formed between the elastic clamping part 312 and the housing 3. It is understandable that the integrated structural design of the clamping element 31 and the housing 3 not only simplifies the manufacturing process, but also enhances the overall stability and durability. The clamping gap formed by the elastic clamping part 312 can adapt to books of different thicknesses, which improves the universality and the practicability of the clamping components.

Optionally, the clamping element 31 and/or the housing 3 are provided with a protecting element (not shown in the figure) which is located in the clamping gap. The protecting element is arranged in the clamping gap, which effectively prevents the clamping component from contacting the books directly, thereby protecting the books from damage. Further optionally, the material of the protecting element is rubber, silicone, polyvinyl chloride, thermoplastic polyurethane, sponge, foam, microfiber or leather. Specifically, the material of the protecting element can be set according to the actual application needs.

Preferably, the clamping element 31 is provided with a first magnetic attraction element 33, and the housing 3 is provided with a second magnetic attraction element 34 for magnetic attraction with the first magnetic attraction element 33. The design of the magnetic attraction elements provides a fast and simple clamping and release mechanism. The users can easily fix or remove the reading lamp. This characteristic greatly improves the use convenience of the product. Specifically, the first magnetic attraction element 33 and the second magnetic attraction element 34 are magnets.

To sum up, the reading lamp provided in the present application combines the advantages of the neckband and clamping reading lamps, and can provide flexible and efficient lighting under different usage scenarios. The first lighting lamp and the clamping components are carried by arranging the deformable flexible carrier. The first lighting lamp is embedded in the middle section position of the flexible carrier, and specially designed for clamping type usage scenarios, and can provide centralized and uniform lighting, thereby optimizing the reading experience of the users. The second lighting lamp is installed on the clamping component. When the reading lamp is converted to a neckband usage scenario, the second lighting lamp provides necessary lighting, so that the users can enjoy sufficient light when walking or standing while reading. The users can realize the conversion of reading modes by adjusting the shape of the flexible carrier combined with the switching of the first lighting lamp and the second lighting lamp, which ensures that the best lighting effect can be provided in different use modes, thereby greatly enhancing the versatility and the user experience of the reading lamp.

The above only describes embodiments of the present application, and is not intended to limit the scope of the patent of the present application. Any equivalent transformation made by using the contents of the description and drawings of the present application and directly or indirectly used in the relevant technical fields is similarly included in the protection scope of the patent of the present application.

What is claimed is:

1. A reading lamp, comprising:
a flexible carrier, which is deformable;
two clamping components, installed at both opposite ends of the flexible carrier respectively;
a first lighting lamp, embedded in a middle section position of the flexible carrier; and
a second lighting lamp, installed on each of the two clamping components.

2. The reading lamp according to claim 1, wherein a material of the flexible carrier is a shape memory polymer, silicone, thermoplastic polyurethane, polyvinyl chloride or nickel-titanium alloy.

3. The reading lamp according to claim 1, wherein each of the two clamping components comprises a housing and a clamping element installed on an outer side of the housing; the housing is installed on an end part of the flexible carrier; the second lighting lamp is installed on the housing; and an electric control assembly electrically connected with the second lighting lamp and the first lighting lamp is arranged in the housing

4. The reading lamp according to claim 3, wherein the electric control assembly comprises a control circuit board, a power supply and a control key; the power supply is electrically connected with the control circuit board; the control circuit board is electrically connected with the first lighting lamp and the second lighting lamp; and the control key is installed outside the housing and is used for sending a control signal to the control circuit board.

5. The reading lamp according to claim 3, wherein the flexible carrier is provided with a wire trough, one end of the housing near the flexible carrier is provided with a wire hole, and the wire hole is arranged against the wire trough.

6. The reading lamp according to claim 4, wherein the flexible carrier is provided with a wire trough, one end of the housing near the flexible carrier is provided with a wire hole, and the wire hole is arranged against the wire trough.

7. The reading lamp according to claim 3, wherein the clamping element and the housing are formed as an integrated structure; the clamping element comprises a fixing part and an elastic clamping part which are connected; the fixing part is connected with the housing; and a clamping gap is formed between the elastic clamping part and the housing.

8. The reading lamp according to claim 7, wherein the clamping element and/or the housing are provided with a protecting element which is located in the clamping gap.

9. The reading lamp according to claim 8, wherein a material of the protecting element is rubber, silicone, polyvinyl chloride, thermoplastic polyurethane, sponge, foam, microfiber or leather.

10. The reading lamp according to claim 3, wherein the clamping element is provided with a first magnetic attraction element, and the housing is provided with a second magnetic attraction element for magnetic attraction with the first magnetic attraction element.

11. The reading lamp according to claim 1, wherein the first lighting lamp is a flexible lamp strip.
